(19) United States
(12) Patent Application Publication
(10) Pub. No.: US 2011/0269896 A1
(43) Pub. Date: Nov. 3, 2011

(54) MOLDED PARTS HAVING IMPROVED SURFACES

(75) Inventors: Rolf Wehrmann, Krefeld (DE); Michael Erkelenz, Duisburg (DE); Gesa Dern, Dusseldorf (DE); Berit Krauter, Neuss (DE)

(73) Assignee: BAYER MATERIAL SCIENCE AG, Leverkusen (DE)

(21) Appl. No.: 12/673,124

(22) PCT Filed: Aug. 19, 2008
(86) PCT No.: PCT/EP2008/006794

§ 371 Date: Feb. 11, 2010

(30) Foreign Application Priority Data
Aug. 30, 2007 (DE) 10 2007 040 926.7

(51) Int. Cl. C08L 33/06; C08L 67/00; C08L 23/00; C08L 25/06; C08L 69/00; C08L 81/06; B82Y 30/00

(52) U.S. Cl. 524/560; 524/612; 524/599; 524/609; 524/570; 524/577; 977/752

(57) ABSTRACT

Moldings obtainable from compositions comprising
A) from 99.91 to 85% by weight of thermoplastic and
B) from 0.09 to 15% by weight of multiwall carbon nanotubes,
   which have a 20° gloss level of from 104 to 20 and a 60° gloss level of from 103 to 50, measured to ISO 2813 using a Byk-Gardner haze-gloss device, and the use of the compositions for the production of moldings with these gloss levels.

Polycarbonates are engineering thermoplastics. Engineering thermoplastics have a wide variety of applications in the electrical and electronic sector, as a material for casings of lamps, and in applications that demand particular mechanical properties. In these applications it is almost always the good thermal and mechanical properties that are required, examples being Vicat point, glass transition temperature and impact resistance. Materials used here include carbon blacks for dark or opaque coloring. A disadvantage of these compositions is often that the articles/moldings manufactured therefrom have a glossy surface. The mold surfaces have to be roughened in order to overcome this disadvantage.

An object was therefore to provide moldings which do not have the abovementioned disadvantages.

Moldings composed of thermoplastics and multiwall carbon nanotubes (MWCNT) have been found not to have said disadvantages.

EP-A 1770126 describes polycarbonate compositions which comprise a fluorine-containing organic metal salt, at least one further component from the group consisting of a flame retardant, of a fatty acid ester, of a UV absorber, PTFE fibers, of a filler, of a silicate mineral and of a titanium dioxide pigment. Fillers mentioned are a wide variety of fillers among which those known as MWCNT (multiwall carbon nanotubes) are also mentioned. No specific examples comprising MWCNT are described.

JP 2006-291081 A, JP 2006-193649 A, JP 2006-016553 A and WO 2008/078850 A describe the use of MWCNT in polycarbonate. However, the cited patent applications do not describe moldings composed of polycarbonate and MWCNT with a particular gloss level.

The present invention therefore provides moldings obtainable from compositions comprising
A) from 99.91 to 85% by weight, preferably from 99.90 to 88% by weight, particularly preferably from 99.88 to 93% by weight, very particularly preferably from 99.70 to 93% by weight, in particular from 98 to 94% by weight, of thermoplastic and
B) from 0.09 to 15% by weight, preferably from 0.1 to 12% by weight, particularly preferably from 0.12 to 7% by weight, very particularly preferably from 0.3 to 7% by weight, in particular from 2 to 6% by weight, of multiwall carbon nanotubes,
   which have a 20° gloss level of from 104 to 20, preferably from 100 to 20, particularly preferably from 40 to 22, and a 60° gloss level of from 103 to 50, preferably from 100 to 50, particularly preferably from 80 to 55, measured to ISO 2813 using a Byk-Gardner haze-gloss device.

The present invention further provides the use of compositions comprising
A) from 99.91 to 85% by weight, preferably from 99.90 to 88% by weight, particularly preferably from 99.88 to 93% by weight, very particularly preferably from 99.70 to 93% by weight, in particular from 98 to 94% by weight, of thermoplastic and
B) from 0.09 to 15% by weight, preferably from 0.1 to 12% by weight, particularly preferably from 0.12 to 7% by weight, very particularly preferably from 0.3 to 7% by weight, in particular from 2 to 6% by weight, of multiwall carbon nanotubes,
   for the production of moldings which have a 20° gloss level of from 104 to 20, preferably from 100 to 20, particularly preferably from 40 to 22, and a 60° gloss level of from 103 to 50, preferably from 100 to 50, particularly preferably from 80 to 55, measured to ISO 2813 using a Byk-Gardner haze-gloss device.

Particularly suitable thermoplastics are transparent thermoplastics, such as polycarbonate, polyester, e.g. polyethylene terephthalate and polybutylene terephthalate, polysulfones, polyethers, polyolefins, cycloolefin copolymers, polystyrenes and polyacrylates. Preferred thermoplastic is polycarbonate. However, opaque compositions are also suitable, examples being polycarbonate-based blends, e.g. with polyesters, SAN, ABS, and/or polylactate.

Multiwall carbon nanotubes (MWCNT) are preferably cylindrical carbon tubes with >95% carbon content, comprising no amorphous carbon. The carbon nanotubes preferably have an external diameter of from 3 to 80 nm, particularly preferably from 5 to 20 nm. The average external diameter is preferably from 13 to 16 nm. The length of the cylindrical carbon nanotubes is preferably from 0.1 to 20 μm, particularly preferably from 1 to 10 μm. The carbon nanotubes are preferably composed of from 2 to 50, particularly preferably from 3 to 15, graphitic sublayers (also termed “layers” or “walls”), the minimum internal diameter of which is from 2 to 6 nm. “Carbon fibrils” and “hollow carbon fibers” are examples of other terms used for said carbon nanotubes.

The production of the MWCNT used in the invention is well known (cf., for example, U.S. Pat. No. 5,643,502 and DE 10 2006 017 695 A1, the preferred production process being that of DE 10 2006 017 695 A1, and particularly the method of Example 3 of DE 10 2006 017 695 A1).

For the purposes of the present invention, thermoplastic, aromatic polycarbonates are not only homopolycarbonates but also copolycarbonates; as is known, the polycarbonates can be linear or branched polycarbonates.

The average molar masses M_{w} of the thermoplastic polycarbonates, inclusive of the thermoplastic, aromatic polyester carbonates, is from 12 000 to 120 000 g/mol, preferably from 15 000 to 80 000 g/mol, in particular from 18 000 to 60 000 g/mol, very particularly preferably from 18 000 to 40 000 g/mol (determined by gel permeation chromatography with polycarbonate calibration).

A portion, up to 80 mol %, preferably from 20 mol % to 50 mol %, of the carbonate groups in the polycarbonates suitable for the invention can have been replaced by aromatic dicarboxylic ester groups. These polycarbonates which incorporate, into the molecular chain, not only acid moieties from carbonic acid but also acid moieties from aromatic dicarboxylic acids are termed aromatic polyester carbonates. The present application subsumes them within the umbrella term “thermoplastic, aromatic polycarbonates” for purposes of simplicity.

The polycarbonates are produced in a known manner from diphenols, carbonic acid derivatives, and if appropriate chain terminators and if appropriate branching agents, and production of the polyester carbonates here involves replacing a portion of the carbonic acid derivatives by aromatic dicarboxylic acids or derivatives of the dicarboxylic acids, and indeed are replaced by aromatic dicarboxylic ester structural units to the extent to which the carbonate structural units in the aromatic polycarbonates are to be replaced.

Dihydroxyaryl compounds suitable for the production of polycarbonates are those of the formula (2)

HO—Z—OH (2)

in which
Z is an aromatic moiety which has from 6 to 30 carbon atoms and which can contain one or more aromatic rings, and can have substitution and can contain aliphatic or cycloaliphatic moieties and, respectively, alkylaryl moieties or heteroatoms as bridging members.
Z in formula (2) is preferably a moiety of the formula (3)

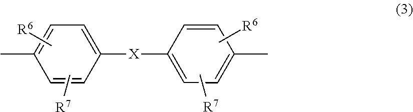

in which
R⁶ and R⁷, independently of one another, are H, C₁-C₁₈-alkyl, C₁-C₁₈-alkoxy, halogen, such as Cl or Br, or, respectively optionally substituted, aryl or aralkyl, preferably H or C₁-C₁₂-alkyl, particularly preferably H or C₁-C₈-alkyl and very particularly preferably H or methyl, and
X is a single bond, —SO₂—, —CO—, —O—, —S—, C₁-C₆-alkylene, C₂-C₅-alkylidene or C₅-C₆-cycloalkylidene, which can have substitution by C₁-C₆-alkyl, preferably by methyl or ethyl, or else X is C₆-C₁₂-arylene, which, if appropriate, can have been condensed with further aromatic rings containing heteroatoms.

It is preferable that X is a single bond, C₁-C₅-alkylene, C₂-C₅-alkylidene, C₅-C₆-cycloalkylidene, —O—, —SO—, —CO—, —S—, —SO₂—,

or a moiety of the formula (3a) or (3b)

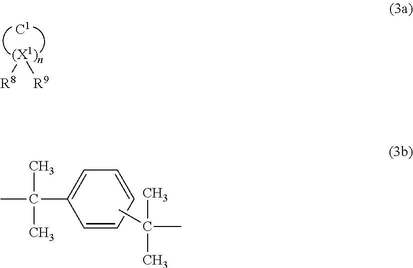

where
R⁸ and R⁹ are individually selectable for each X¹ and, independently of one another, are hydrogen or C₁-C₆-alkyl, preferably hydrogen, methyl or ethyl, and
X¹ is carbon, and
n is a whole number from 4 to 7, preferably 4 or 5, with the proviso that R⁸ and R⁹ are simultaneously alkyl on at least one atom X¹.

Examples of dihydroxyaryl compounds (diphenols) are: dihydroxybenzenes, dihydroxybiphenyls, bis(hydroxyphenyl)alkanes, bis(hydroxyphenyl)cycloalkanes, bis(hydroxyphenyl)aryl compounds, bis(hydroxyphenyl)ethers, bis(hydroxyphenyl) ketones, bis(hydroxyphenyl) sulfides, bis(hydroxy-phenyl) sulfones, bis(hydroxyphenyl) sulfoxides, 1,1′-bis(hydroxyphenyl)diisopropylbenzenes, and the ring-alkylated and ring-halogenated compounds related to these.

Examples of diphenols suitable for the production of the polycarbonates to be used in the invention are hydroquinone, resorcinol, dihydroxybiphenyl, bis(hydroxyphenyl)alkanes, bis(hydroxy-phenyl)cycloalkanes, bis(hydroxyphenyl) sulfides, bis(hydroxyphenyl)ethers, bis(hydroxyphenyl) ketones, bis(hydroxyphenyl) sulfones, bis(hydroxyphenyl) sulfoxides, -bis(hydroxy-phenyl)diisopropylbenzenes, and also the alkylated, ring-alkylated and ring-halogenated compounds related to these.

Preferred diphenols are 4,4′-dihydroxybiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxybiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These, and other, suitable diphenols are described by way of example in U.S. Pat. Nos. 2,999,835, 3,148,172, 2,991,273, 3,271,367, 4,982,014 and 2,999,846, in German laid-open applications 1 570 703, 2 063 050, 2 036 052, 2 211 956 and 3 832 396, in French Patent 1 561 518, in the monograph “Chemistry and Physics of Polycarbonates”, Interscience Publishers, New York 1964, pp. 28 ff; pp. 102 ff by H. Schnell, and in D. G. Legrand, J. T. Bendier, “Handbook of Polycarbonate Science and Technology”, Marcel Dekker New York 2000, pp. 72 ff.

In the case of the homopolycarbonates, only one diphenol is used, but in the case of copolycarbonates two or more diphenols are used. The diphenols used can, and this also applies to all of the other chemicals and auxiliaries added to the synthesis reaction, have contaminants derived from their own synthesis, handling and storage. However, it is desirable to use raw materials of maximum purity.

The monofunctional chain terminators needed for molecular weight regulation, e.g. phenol or alkylphenols, in particular phenol, p-tert-butylphenol, isooctylphenol, cumylphenol, the carbonyl chloride esters of these or acyl chlorides of monocarboxylic acids, or a mixture of said chain terminators, are introduced to the reaction either with the bisphenolate(s) or else at any desired juncture in the synthesis reaction, as long as phosgene or carbonyl chloride end groups are still present in the reaction mixture, or, in the case of the acyl chlorides and carbonyl chloride esters as chain terminators, as long as sufficient phenolic end groups of the polymer that is being formed are available. However, it is preferable that the chain terminator(s) is/are added after the phosgenation reaction at a location or at a juncture at which no remaining phosgene is present, but before addition of the catalyst; they are added before the catalyst, together with the catalyst, or in parallel therewith.

The same method is used to add, to the synthesis reaction, any branching agents or branching agent mixtures to be used, but they are usually added before the chain terminators. The compounds usually used are trisphenols, quaterphenols or acyl chlorides of tri- or tetracarboxylic acids, or else a mixture of the polyphenols or of the acyl chlorides.

Examples of some of the compounds that can be used as branching agents having three or more than three phenolic hydroxy groups are phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol and tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of the branching agents that can be used if appropriate is from 0.05 mol % to 2 mol %, again based on a mole of respective diphenols used.

The branching agents can either be used as initial charge in the aqueous alkaline phase with the diphenols and the chain terminators, or can be added prior to phosgenation, after dissolution in an organic solvent.

All of said measures for the production of the polycarbonates are familiar to the person skilled in the art.

Examples of aromatic dicarboxylic acids suitable for the production of the polyester carbonates are orthophthalic acid, terephthalic acid, isophthalic acid, tert-butylisophthalic acid, 3,3′-biphenyl-dicarboxylic acid, 4,4′-biphenyldicarboxylic acid, 4,4-benzophenonedicarboxylic acid, 3,4′-benzo-phenonedicarboxylic acid, 4,4′-diphenyl ether dicarboxylic acid, 4,4′-diphenyl sulfone dicarboxylic acid, 2,2-bis(4-carboxyphenyl)propane, and trimethyl-3-phenylindane-4,5′-dicarboxylic acid.

Among the aromatic dicarboxylic acids, terephthalic acid and/or isophthalic acid are particularly preferably used.

Derivatives of the dicarboxylic acids are the diacyl dihalides and the dialkyl dicarboxylates, in particular the diacyl dichlorides and the dimethyl dicarboxylates.

The replacement of the carbonate groups by the aromatic dicarboxylic ester groups takes place in essence stoichiometrically and also quantitatively, and the molar ratio of the reactants is therefore reflected in the final polyester carbonate. The aromatic dicarboxylic ester groups can be incorporated either randomly or blockwise.

Preferred production methods for the polycarbonates to be used in the invention, inclusive of the polyester carbonates, are the known interfacial process and the known melt transesterification process (cf., for example, WO 2004/063249 A1, WO 2001/05866 A1, WO 2001/005867, U.S. Pat. No. 5,340,905, U.S. Pat. No. 5,097,002, U.S. Pat. No. 5,717,057).

In the first instance, phosgene and, if appropriate, diacyl dichlorides preferably serve as acid derivatives, and in the latter instance diphenyl carbonate and, if appropriate, dicarboxylic diesters preferably serve as acid derivatives. In both instances, catalysts, solvents, work-up, reaction conditions, etc. for production of polycarbonate or production of the polyester carbonate have been widely described and are well known.

The polycarbonates, polyester carbonates, and polyesters can be worked up in a known manner and processed to give any desired moldings, for example via extrusion or injection molding.

Conventional amounts of the additives conventional for these thermoplastics, e.g. fillers, UV stabilizers, heat stabilizers, antistatic agents, dyes and pigments, mold-release agents, IR absorbers, and flame retardants, can also be added to the polycarbonate compositions. It is particularly preferable to use only those which do not impair the transparency of the material.

Examples of suitable additives are described in “Additives for Plastics Handbook”, John Murphy, Elsevier, Oxford 1999, and in “Plastics Additives Handbook”, Hans Zweifel, Hanser, Munich, 2001.

Examples of suitable antioxidants or heat stabilizers are:

alkylated monophenols, alkylthiomethylphenols, hydroquinones and alkylated hydroquinones, tocopherols, hydroxylated thiodiphenyl ethers, alkylidenebisphenols, O-, N-, and S-benzyl compounds, hydroxybenzylated malonates, aromatic hydroxybenzyl compounds, triazine compounds, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenylacetic acid, amides of β-(3,5-di-tert-butyl-4-hydroxyphenyl)propionic acid, suitable thiosynergists, secondary antioxidants, phosphites, and phosphonites, benzofuranones, and indolinones.

Preference is given to organic phosphites, phosphonates, and phosphanes, mostly those in which the organic moieties are entirely or to some extent composed of optionally substituted aromatic moieties.

2,4,6-Tri-tert-butylphenyl(2-butyl-2-ethylpropane-1,3-diyl) phosphite is very particularly preferred as heat stabilizer:

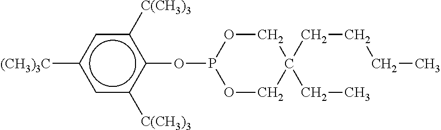

The phosphites can be used alone, but can also be used in combination with other phosphorus compounds, and the other phosphorus compounds here can also be those which have a different oxidation number of the phosphorus atom. Accordingly, for example, combinations of the phosphites of the invention with other phosphites, with phosphines, such as triphenylphosphine, with phosphonites, with phosphates, with phosphonates, etc. can be used. Phosphines can also be used alone, an example being triphenylphosphine or tritolylphosphine.

The phosphites used are well known or can be produced by analogy with known phosphites; 2,4,6-tri-tert-butylphenyl(2-butyl-2-ethylpropane-1,3-diyl) phosphite is by way of example described in EP-A 702 018 and EP 635 514.

The proportion of the phosphorus compound generally present in the polymer mixtures is from 10 to 5000 ppm, preferably from 10 to 1000 ppm, particularly preferably from 20 to 700 ppm, very particularly preferably from 50 to 500 ppm.

In an example of a preferred method for adding the mold-release agents, the phosphorus compound, and the formals to the thermoplastic molding compositions, they are metered into the material after the production process and during the work-up of the polycarbonates, e.g. via addition to the polycarbonate polymer solution, or to a melt of the thermoplastic molding compositions. It is also possible to meter the components into the material independently of one another in different operations, e.g. one of the components during the work-up of the polymer solution and the other component(s) in the melt, as long as the method ensures that all of the components are present during the production of the end products (moldings).

Very particularly suitable additives are IRGANOX 1076®, see above, and benzotriazoles of group 2.1 (“Tinuvins”), in particular in a mixture with one another, and triphenylphosphine (TPP).

Suitable flame retardants C) are: the alkali metal or alkaline earth metal salts of derivatives of aliphatic or aromatic sulfonic acids and, respectively, sulfonamides and sulfonimides, examples being potassium perfluorobutanesulfonate, potassium diphenyl sulfone sulfonate, the potassium salt of N-(p-tolylsulfonyl)-p-toluenesulfimide, and the potassium salt of N—(N′-benzylaminocarbonyl)sulfanylimide.

Examples of salts which can be used, if appropriate, in the molding compositions are:

sodium or potassium perfluorobutane sulfate, sodium or potassium perfluoromethanesulfonate, sodium or potassium perfluorooctane sulfate, sodium or potassium 2,5-dichlorobenzene sulfate, sodium or potassium 2,4,5-trichlorobenzene sulfate, sodium or potassium methylphosphonate, sodium or potassium (2-phenylethylene)phosphonate, sodium or potassium pentachlorobenzoate, sodium or potassium 2,4,6-trichlorobenzoate, sodium or potassium 2,4-dichlorobenzoate, lithium phenyl-phosphonate, sodium or potassium diphenyl sulfone sulfonate, sodium or potassium 2-formylbenzene-sulfonate, sodium or potassium (N-benzenesulfonyl)benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, the potassium salt of N-(p-tolylsulfonyl)-p-toluenesulfimide, and the potassium salt of N—(N′-benzylaminocarbonyl)sulfanylimide.

Preference is given to sodium or potassium perfluorobutane sulfate, sodium or potassium fluorooctane sulfate, sodium or potassium diphenyl sulfone sulfonate, and sodium or potassium 2,4,6-trichloro-benzoate, and the potassium salt of N-(p-tolylsulfonyl)-p-toluenesulfimide, and the potassium salt of N—(N′-benzylaminocarbonyl)sulfanylimide. Very particular preference is given to potassium perfluorobutane sulfate and sodium or potassium diphenyl sulfone sulfonate.

Mixtures of these salts are also suitable.

The amounts used of these organic flame-retardant salts in the molding compositions are from 0.01 to 0.1 part by weight, preferably from 0.01 to 0.08 part by weight, particularly preferably from 0.01 to 0.06 part by weight and very particularly preferably from 0.01 to 0.03 part by weight (based on polymer composition).

The compositions can also comprise suitable PTFE blends. All of these are physical mixtures of PTFE (polytetrafluoroethylene) with a substance which takes the form of layers and which is compatible with polycarbonate and, respectively, polyester carbonate and with PTFE, and which retains the fibril structure of the PTFE chains. Examples of suitable substances are styrene-acrylonitrile copolymers (SAN) and polyacrylates. The proportions of PTFE in said blends are from 20 to 80% by weight, preferably from 20 to 70% by weight, and very particularly from 30 to 60% by weight. These blends are commercially available, for example with trademark Blendex® B449 from GE Speciality Chemicals or Metablen® A product line from Mitsubishi Rayon. The blends are prepared by mixing of a PTFE emulsion with an emulsion of the suitable blend partner. A suitable process such as coagulation, freeze drying, spray drying, etc. is used on the resultant mixture to obtain the blend.

Alkali metal salts and alkaline earth metal salts are known for the production of flame-retardant polycarbonate, see by way of example: U.S. Pat. Nos. 3,775,367, 3,836,490, 3,933,734, 3,940,366, 3,953,399, 3,926,908, 4,104,246, 4,469,833, 4,626,563, 4,254,015, 4,626,563 and 4,649,168.

These substances can be found in many publications, for example in Additives for Plastics Handbook, John Murphy, 1999, and are commercially available.

1. Examples of suitable antioxidants are:
1.1. Alkylated monophenols, e.g. 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols having a linear or branched side chain, e.g. 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol.

### 1.2. Alkylthiomethylphenols

1.3. Hydroquinones and alkylated hydroquinones

### 1.4. Tocopherols

### 1.5. Hydroxylated Thiodiphenyl Ethers

### 1.6. Alkylidenebisphenols

1.7. O-, N- and S-benzyl compounds

### 1.8. Hydroxybenzylated Malonates

### 1.9. Aromatic Hydroxybenzyl Compounds

1.10. Triazine compounds

### 1.11. Acylaminophenols

1.12. Esters of β-(3,5-di-tert-butyl-4-hydroxyphenyl)propionic acid with mono- or polyhydric alcohols, a compound which is very particularly suitable and preferred here being the ester with octadecanol (IRGANOX 1076® from Ciba Spec.)
1.13. Esters of β-(5-tert-butyl-4-hydroxy-3-methylphenyl)propionic acid with mono- or polyhydric alcohols
1.14. Esters of β-(3,5-dicyclohexyl-4-hydroxyphenyl)propionic acid with mono- or polyhydric alcohols
1.15. Esters of 3,5-di-tert-butyl-4-hydroxyphenylacetic acid with mono- or polyhydric alcohols
1.16. Amides of β-(3,5-di-tert-butyl-4-hydroxyphenyl)propionic acid
1.17. Ascorbic acid (vitamin C)

### 1.18. Aminic Antioxidants

1.19. Examples of suitable thiosynergists are dilauryl thiodipropionate and/or distearyl thiodipropionate.
2. Amounts, based on the weight of the composition, of from 0.1 to 15% by weight, preferably from 3 to 8% by weight, of UV absorbers and light stabilizers can be used in the compositions of the invention. Examples of suitable UV absorbers and light stabilizers are:
2.1. 2-(2′-hydroxyphenyl)benzotriazoles, e.g. 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenylbenzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy) carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzo-triazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)-carbonylethyl]-2′-hydroxyphenyl)benzotriazole, 2-(3′-dodecyl-2′-hydroxy-5′-methylphenyl)benzo-triazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the trans esterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

### 2.2. 2-Hydroxybenzophenones

2.3. Esters of substituted and unsubstituted benzoic acids

### 2.4. Acrylates

2.5. Nickel compounds

### 2.6. Sterically Hindered Amines

### 2.7. Oxamides

2.8. 2-(2-Hydroxyphenyl)-1,3,5-triazines.

These compounds can be used individually, or mixtures of the same can be used.

WO 06/012993, for example, gives examples of compound classes 1 and 2.

3. Examples of suitable metal deactivators are N,N′-diphenyloxamide, N-salicylal-N′-salicyloylhydrazine, N,N′-bis(salicyloyl)hydrazine, N,N′-bis(3,5-di-tert-butyl-4-hydroxyphenyl-propionyl)hydrazine, 3-salicyloylamino-1,2,4-triazole, bis(benzylidene)oxalyl dihydrazide, oxanilide, isophthaloyl dihydrazide, sebacoylbisphenyl hydrazide, N,N′-diacetyladipoyl dihydrazide, N,N′-bis(salicyloyl)oxalyl dihydrazide, N,N′-bis(salicyloyl)thiopropionyl dihydrazide. These compounds can be used individually, or mixtures of the same can be used.
4. Examples of suitable peroxide scavengers are esters of β-thiodipropionic acid, e.g. the lauryl, stearyl, myristyl, or tridecyl esters, mercaptobenzimidazole, or the zinc salt of 2-mercapto-benzimidazole, zinc dibutyldithiocarbamate, dioctadecyl disulfide, pentaerythritol tetrakis-(dodecylmercapto)propionate. These compounds can be used individually, or mixtures of the same can be used.
5. Examples of suitable basic costabilizers are melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, e.g. calcium stearate, zinc stearate, magnesium behenate, magnesium stearate, sodium ricinoleate and potassium palmitate, antimony pyrocatecholate, or zinc pyrocatecholate. These compounds can be used individually, or mixtures of the same can be used.
6. Examples of suitable nucleating agents are inorganic substances, e.g. talc, metal oxides, such as titanium dioxide or magnesium oxide, phosphates, carbonates, or sulfates, preferably of alkaline earth metals; organic compounds, e.g. mono- or polycarboxylic acids and their salts, e.g. 4-tert-butylbenzoic acid, adipic acid, diphenylacetic acid, sodium succinate, or sodium benzoate; polymeric compounds, such as ionic copolymers (ionomers). Particular preference is given to 1,3:2,4-bis(3′,4′-dimethylbenzylidene)sorbitol, 1,3:2,4-di(paramethyldibenzylidene)sorbitol, and 1,3:2,4-di(benzylidene)sorbitol. These compounds can be used individually, or mixtures of the same can be used.
7. Examples of suitable fillers and reinforcing agents are calcium carbonate, silicates, glass fibers, glass balloons, asbestos, talc, kaolin, mica, barium sulfate, metal oxides and metal hydroxides, carbon black, graphite, wollastonite, wood flour, and flours or fibers derived from other natural products, and synthetic fibers. These compounds can be used individually, or mixtures of the same can be used.
8. Examples of suitable other additives are plasticizers, lubricants, emulsifiers, pigments, viscosity modifiers, catalysts, flow agents, optical brighteners, flame retardants, antistatic agents, and blowing agents.
9. Examples of suitable benzofuranones and indolinones are those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, or EP-A-0591102, or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxy-phenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, and lactone antioxidants, such as

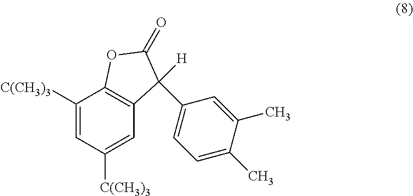

These compounds act as antioxidants, for example. These compounds can be used individually, or mixtures of the same can be used.

10. Suitable fluorescent plasticizers are those listed in “Plastics Additives Handbook”, eds. R. Gächter and H. Müller, Hanser Verlag, 3^{rd} edition, 1990, pages 775-789.
11. Suitable flame-retardant additives are phosphate esters, i.e. triphenyl phosphate, resorcinol diphosphate, bromine-containing compounds, e.g. brominated phosphoric esters, brominated oligocarbonates, and polycarbonates, and also salts, such as C₄F₉SO₃⁻Na⁺.
12. Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, and interpenetrating siloxane and acrylate networks with grafted-on methyl methacrylate or styrene-acrylonitrile.
13. Suitable antistatic agents are sulfonate salts, e.g. tetraethylammonium salts or phosphonium salts of C₁₂H₂₅SO³⁻ or C₈F₁₇SO³⁻.
14. Suitable colorants are pigments and organic and inorganic dyes.
15. Compounds containing epoxy groups, e.g. 3,4-epoxycyclohexylmethyl 3,4-epoxycyclo-hexylcarboxylate, copolymers of glycidyl methacrylate, and epoxy silanes.
16. Compounds containing anhydride groups, e.g. maleic anhydride, succinic anhydride, benzoic anhydride, and phthalic anhydride.
17. Phosphites and phosphonites suitable as stabilizers. These compounds can be used individually, or mixtures of the same can be used.

Particular preference is given to tris(2,4-di-tert-butylphenyl) phosphite (Irgafos CD 168, Ciba-Geigy) or triphenylphosphine.

The moldings of the invention can be processed conventionally starting from the compositions in conventional machinery, for example in extruders or injection-molding machinery, to give any desired moldings, foils, or panels.

Possible moldings are safety-glazing panes, which are known to be required in many regions of buildings, of vehicles, and of aircraft, and also as shields in helmets. Production of extruded foils and of solution-based films for displays, blister packs, or electric motors, blown products (see, for example, U.S. Pat. No. 2,964,794), translucent panels, in particular panels having cavities, for example for the protective covering of buildings, such as railroad stations, greenhouses, and lighting systems, traffic-signal casings, traffic signs, moldings for lighting purposes and protective goggles. As electrical-insulation materials for electrical conductors and for plug casings, and plug connectors. As substrate material for organic photoconductors, lamps, or light-scattering panels, or lamp covers, casing parts, e.g. electrical distribution cabinets, electrical devices, household devices. Components of household items, of electrical devices, and of electronic devices, motorcycle helmets and safety helmets, automobile parts, such as glazing, sunroofs, dashboards, bodywork parts, and transportation frames and storage containers for electronic components.

Particularly preferred moldings are:

Safety-glazing panes, translucent panels or moldings for the construction sector, in particular panels having cavities, light-scattering panels, and lamp covers, sunroofs, automobile parts, casing parts, and packaging materials for the electrical industry.

### EXAMPLES

The multiwall carbon nanotubes (MWCNT) used were Baytubes® DP-HP, Bayer MaterialScience AG, 51368 Leverkusen, Germany. They are composed of from 3 to 15 graphitic sublayers with minimum internal diameter of from 2 to 6 nm, the tube lengths being from 1 to 10 μm, and the external diameter of the tubes being from 5 to 20 nm (average value from 13 to 16 nm).

The carbon blacks used were purchased from Degussa AG (Dusseldorf, Germany) (lamp black 101) or from Cabot Corp. (Boston Mass., USA) (Black Pearls 800).

Bisphenol-A-based polycarbonate (Makrolon® 2805, Bayer MaterialScience AG, 51368 Leverkusen, Germany) with MVR of 9.5 cm³/(10 min.) (measured to ISO 1133 (300° C., 1.2 kg)) was provided with various contents of the MWCNT described above and carbon blacks, via compounding, using a ZSK 25 (from Paul Beier KG, Kassel, Germany). Tables 1 and 2 list the constitutions together with the glass level values for the test specimens.

The test specimens (60×40×4 mm) were manufactured via injection molding in an Allrounder 370C 800-250 (from Arburg GmbH & Co. KG, Loβburg, Germany), using a mold with polished surfaces.

Gloss values were measured in a Byk-Gardner haze-gloss device to ISO 2813 (ASTM D523) at angles of 20° and 60°.

The tables below collate the results (quantitative data in % by weight):

TABLE 1
Gloss values for Baytubes DP-HP in PC

| | Content of Baytubes ® | | |
|---|---|---|---|
| | DP-HP | 20° gloss level | 60° gloss level |
| Example 1 | 0.16% | 102.0 | 102.0 |
| Example 2 | 0.50% | 92.9 | 99.9 |
| Example 3 | 5.00% | 28.7 | 68.8 |

TABLE 2
Gloss values for carbon black in PC

| | Content of Black Pearls | | |
|---|---|---|---|
| | 800 | 20° gloss level | 60° gloss level |
| Example 4 | 0.16% | 105.5 | 104.0 |
| (comparison) | | | |

Table 1 clearly shows a reduction in gloss level (i.e. an increase in the mattness of the surface) with rising Baytubes DP-HP fill level. Comparison with the data in Table 2 (Example 4) shows that addition of Black Pearls 800 leads to a distinctly smaller reduction in gloss value.

1. A molding, formed from a composition comprising
A) from 99.91 to 85% by weight of thermoplastic and
B) from 0.09 to 15% by weight of multiwall carbon nanotubes,
said molding having a 20° gloss level of from 104 to 20 and a 60° gloss level of from 103 to 50, measured to ISO 2813 using a Byk-Gardner haze-gloss device.

2. The molding as claimed in claim 1, comprising from 99.90 to 88% by weight of thermoplastic and from 0.1 to 12% by weight of multiwall carbon nanotubes.

3. The molding as claimed in claim 2, comprising from 98 to 94% by weight of thermoplastic and from 2 to 6% by weight of multiwall carbon nanotubes.

4. The molding as claimed in claim 1, having a 20° gloss level of from 100 to 20 and a 60° gloss level of from 100 to 50.

5. The molding as claimed in claim 4, having a 20° gloss level of from 40 to 22 and a 60° gloss level of from 80 to 55.

6. The molding as claimed in claim 1, where the thermoplastic is selected from the group consisting of polycarbonates, polyesters, polysulfones, polyolefins, polystyrenes, and polyacrylates.

7. The molding of claim 1, wherein said molding is a construction molding, a safety-glazing pane, a panel, a light-scattering panel, a lamp cover, a sunroof, a casing part, a packaging material for electrical and electronic items, or an automobile part.

8. A method for producing moldings which have a 20° gloss level of from 104 to 20 and a 60° gloss level of from 103 to 50, measured to ISO 2813 using a Byk-Gardner haze-gloss device, which comprises producing such moldings from a composition comprising:
A) from 99.91 to 85% by weight of thermoplastic and
B) from 0.09 to 15% by weight of multiwall carbon nanotubes.
